(19) United States
(12) Patent Application Publication
(10) Pub. No.: US 2017/0188512 A1
(43) Pub. Date: Jul. 6, 2017

(54) Producing High Yielding Seeds

(71) Applicant: Michael E. Fromm, Lincoln, NE (US)

(72) Inventor: Michael E. Fromm, Lincoln, NE (US)

(21) Appl. No.: 15/397,470

(22) Filed: Jan. 3, 2017

Related U.S. Application Data
(60) Provisional application No. 62/275,602, filed on Jan. 6, 2016.

(51) Int. Cl. A01D 41/127; A01F 12/18; A01F 12/46; A01D 69/00; A01F 12/60

(52) U.S. Cl. CPC A01D 41/127; A01D 69/00; A01F 12/60; A01F 12/46; A01F 12/18; A01D 2101/00

(57) ABSTRACT

A single plant harvesting machine capable of harvesting 1 to 10 single plants concurrently wherein the seeds of each single plant are separately harvested, packaged, and stored. A large scale production system for producing high yield potential seeds from individually harvested plants is also provided.

### CROSS-REFERENCE FOR RELATED APPLICATIONS

None

### STATEMENT REGARDING FEDERALLY SPONSORED RESEARCH OR DEVELOPMENT

None

### BACKGROUND OF INVENTION

Harvesting seeds or fruits from a single plant is a common task in plant breeding that is usually not automated with machinery in the field. U.S. Patent Application No. US2002/0043059 A1 describes a partially automated system of harvesting individual plants and is suitable only for small scale harvesting of single plants.

Phenotypic trait stability is more variable in each generation for traits that have an epigenetic basis than for traits with a more stable genetic basis. The Msh1 suppression/restoration system is one such epigenetic system (Yang et al., Plant Physiol. 2015 May; 168 (1):222-32; de la Rosa Santamaria et al., PLoS One. 2014 Oct. 27; 9 (10):e108407; Virdi et al., Nat Commun. 2015 Feb. 27; 6:6386; US Patent Application No. 20150189842). Additional uncharacterized systems may exist as well as there is a growing appreciation for the role of epigenetics in plant traits (see Introduction of Yang et al., Plant Physiol. 2015 May; 168 (1): 2-3).

### SUMMARY OF INVENTION

The present invention provides a harvester machine for large scale harvesting of individual plants in a manner that separately collects seeds from individual plants. The yields of individual plants is measured and seeds are saved or discarded according to a yield threshold established by the user. The seeds saved from individual plants can be stored in bulk or in separate containers.

The rows or plots in the fields to be harvested are planted at lower than normal plant densities to facilitate harvesting individual plants. Individual plants are separated by at least about 6 to 12 inches, preferably 18 inches, and most preferably by 24 inches or more. This spacing helps the harvester to harvest individual plants along a row without harvesting adjacent plants.

In certain embodiments a single plant harvester can concurrently harvest one or more individual plants across a number of rows, keeping the seeds from each plant separate. The seed yield from each plant is measured and saved or discarded according to a yield threshold set by the operator. Saved seeds from each plant can be separately packaged to maintain their relationship to a parental plant or saved in bulk. An alternative method is to package all the seeds lots in the harvester and later measure the seed yields in the harvester or off the harvester for determining which seed lots to save.

In a subsequent seed production step, seeds from individual parental plants are planted in rows or plots wherein one or more rows or plots are derived from a single parental plant. Subsequent harvesting of seeds from all the progeny plants of a single parental plant provides yields from the collective progeny. This collective yield is used to determine which set of one or more rows or plots from a single parental plant are to be saved according to a user determined yield threshold per row or plot.

An exemplary non-limiting embodiment is to save seeds from the top 20% to 80%, more preferably 20% to 50% of the higher yielding plants or rows or plots after initially deciding a yield threshold. Yield thresholds can be determined by a variety of methods, including but not limited to, by first measuring some subset of plants or rows sufficient for an initial estimate of the yield variation, which can be constantly monitored and adjusted as larger numbers of plants are harvested and their seed yield measured, or by packaging the seeds of each set and retroactively deciding which sets of seeds to keep or discard. Alternatively, all the seed packages can be saved and planted, and the yields of the plant rows or plots used to determine which seed lots to save or discard. Additional generations of yield measurements of progeny descended from an initial parental plant can be similarly conducted.

A single plant harvester is comprised of an initial Head (Head & Cutter) unit that directs a plant to the Cutter that cuts the stem of an individual plant, a Feeder that transports the cut plant to the Thresher unit that separates the seeds from the non-seed plant materials, a Separator unit that separates and collects the seeds and discards the non-seed plant materials, a Measurement unit that measures seed yields, a Seed Packaging unit that packages the saved seeds into individual packages, and a Seed Storage or Transfer unit for storing selected seed or seed packages or transfers them to an external storage unit. A single plant harvester can process multiple individual plants as it moves along a set of parallel rows or plots with plants at similar locations along each row. This can be done by keeping the individual harvested plants and seeds separate by having entirely separate harvesting channels (each channel is a group of the units described above). Alternatively, this can be done with different initial harvesting components that share downstream harvester units as long as the final seed packages contain seeds from an individual plant. An exemplary non-limiting embodiment is to have separate Head & Cutter, Feeder, Thresher, and Separator units that use common Seed Measurement and Seed Packaging units operating in a staged manner such that the shared Seed Measurement and Seed Packaging Units only process seeds from one plant at any one time. Other points of connecting the independent steps to the common shared units are also contemplated as the start of the common equipment units such as a common Thresher, or a common Separator, or a common Seed Packaging unit.

Large scale methods of producing high yield potential EpiF3 seeds comprising the steps of: a) harvesting EpiF3 seeds from individual EpiF2 plants with at least one single plant harvester that places said EpiF3 seeds into individual containers; b) measuring the yields from individual EpiF2 plants before or after placing the EpiF3 seeds of step (a) into containers; and c) saving high yield potential EpiF3 seeds harvested from individual EpiF2 plants with yields above a user set threshold are provided herein. In certain embodiments the individual EpiF2 plants are planted at least about 0.3 ft, 0.6 ft, 1 ft, 1.5 ft, or 2 ft apart along the axis the single plant harvester travels along to harvest the plants in the aforementioned method. In certain embodiments high yielding EpiF4 seeds are produced by a method comprising planting high yield potential EpiF3 seeds produced by the aforementioned method and harvesting EpiF4 seeds from the resulting mature EpiF3 plants.

Methods of producing high yield potential EpiF4 seeds comprising the steps of: a) planting a seed lot of high yield potential EpiF3 seeds from an individual EpiF2 plant produced by the aforementioned method in a row or plot; b) harvesting and measuring yields of the EpiF4 seeds from the EpiF3 plants in said row or plot of step (a);and c) saving EpiF4 seeds from an individual row or plot of step (b) with seed yields above a user set threshold yield are provided herein.

Large scale methods of producing high yield potential EpiF4 seeds comprising the steps of: a) harvesting EpiF3 seeds from individual EpiF2 plants with at least one single plant harvester that places said EpiF3 seeds into individual containers; b) planting EpiF3 seed packages ‘package to row or plot’; c) measuring the yields from the EpiF3 rows or plots; and d) saving high yield potential EpiF4 seeds harvested from rows or plots with yields above a user set threshold are provided herein.

A single plant harvester comprising an engine powered platform and a single plant seed collection system comprising a head unit, feeder unit, thresher unit, separator unit, an automated yield measuring system comprising a seed counter or seed weighing device or mass measuring device; and an automated seed saving system comprising a seed packaging unit and a package storage bin or package transfer system is provided herein.

A single plant harvester comprising an engine powered platform and a single plant seed collection system comprising a head unit, feeder unit, thresher unit, separator unit, and an automated seed saving system comprising a seed packaging unit and a package storage bin or package transfer system.

### BRIEF DESCRIPTION OF THE DRAWINGS

FIG. 1 is diagram of how the harvested materials move through the single plant harvester. Labels: 1: Head & Cutter unit; 2: Feeder unit; 3: Thresher unit; 4: Separator unit; 5: Seed Measurement unit; 6: Seed Packaging unit; 7: Seed Storage or Transfer unit.

FIG. 2 is a top view showing an embodiment of a single plant harvester containing two separate processing units. For simplicity only one unit of each duplex processing chain unit is labeled. Labels: 8: side guides of Head unit; 9: stem cutters of Cutter unit; 10: feeder belt; 11: Feeder drum; 12: impeller thresher; 13: cyclone separator; 14: seed counter or weighing unit; 15: Seed Packaging unit; 16: Seed Storage or Transfer unit; 17: Package or seed transfer unit; 18: wheels. Not shown for simplicity is the paddle wheel component of the Head & Cutter unit that pushes the plants onto the feeder belt.

FIG. 3 is a top view showing an embodiment of a single plant harvester containing two separate processing units sharing a downstream seed counter or weighing unit, a Seed Packaging unit; a Seed Storage or Transfer unit, and a Package or seed transfer unit. For simplicity only one unit of each duplex processing chain unit is labeled. Labels: 8: side guides of Head unit; 9: stem cutters of Cutter unit; 10: feeder belt; 11: Feeder drum; 12: impeller thresher; 13: cyclone separator; 14: seed counter or weighing unit; 15: Seed Packaging unit; 16: Seed Storage or Transfer unit; 17: Package or seed transfer unit; 18: wheels. Not shown for simplicity is the paddle wheel component of the Head & Cutter unit that pushes the plants onto the feeder belt.

FIG. 4 is a side view showing an embodiment of a single plant harvester Head & Cutter unit with a paddle wheel component, Feeder belt and drum, and impeller. For simplicity only one unit of a single processing chain unit is shown but these units can be side by side in a multichannel harvester. Labels: 19: stem cutters of Cutter unit with blades and groove that blades move through; 20: feeder belt on rollers that moves plants towards the feeder drum and impeller; 21: Feeder drum to both thresh plants materials and move the now smaller plant parts towards the impeller; 22: impeller thresher that threshes plant materials and provides air flow into the impeller chamber and air flow out of the impeller chamber into the cyclone separator (not shown); 23: impeller motor, which can be electric or hydraulically powered; 24: large arrows show the flow of plant materials; 25: Paddle wheel to push plants onto the feeder belt during and after cutting of the stem by the cutters; 26: metal or plastic enclosure to channel plant materials towards feeder drum and impeller.

FIG. 5 displays an elevated perspective showing the paddle wheel and Head guides on both sides of a Head & Cutter unit. The motor driven paddle wheel has blades almost the width of the feeder belt to push plants onto the feeder belt. Labels: 19: stem cutters of Cutter unit with blades and groove that blades move through; 20: feeder belt on rollers that moves plants towards the feeder drum and impeller; 25: motor driven paddle wheel drum and paddle wheel blades.

FIG. 6 displays the same elevated perspective as FIG. 5 (except the head guide to the right is not shown) showing an embodiment of a single plant harvester Head & Cutter unit (but not showing a paddle wheel component), Feeder belt and drum, and impeller access point. For simplicity only one unit of a single processing chain unit is shown but these units can be side by side in a multichannel harvester. Labels: 19: stem cutters of Cutter unit with blades and groove that blades move through; 20: feeder belt on rollers that moves plants towards the feeder drum and impeller; 21: Feeder drum to both thresh plants materials and move the now smaller plant parts towards the impeller; 22: impeller thresher port; 23: feeder drum motor, which can be electric or hydraulically powered; 24: cutter motor, which can be electric or hydraulically powered; 27: one guide for Head and Cutter unit.

### DETAILED DESCRIPTION OF THE INVENTION

### Definitions

As used herein, the term “EpiF1” refers to the first progeny (seeds or plants) of a cross between two epigenetically different plants regardless of any genetic diversity. As such, crossing heterotic plants with genetic and epigenetic differences meets this definition. “EpiF2” refers to progeny from the self pollination of the EpiF1 plant. “EpiF3” refers to progeny from the self pollination of the F2 plant. “EpiF4” refers to progeny from the self pollination of the EpiF3 plant. “EpiF5” refers to progeny from the self pollination of the EpiF4 plant. In general “EpiFn” refers to progeny from the self pollination of the EpiF(n−1) plant, where “n” is the number of generations starting from the initial EpiF1 cross.

As used herein, the phrase “epigenetically different” refers to plants with different DNA methylation patterns when their genomic DNA is analyzed for DNA methylation levels at compable specific nucleotide positions in the genome. This analysis can be the whole genome DNA methylome or one or more specific regions of the genome. A specific, non-limiting example of epigenetically different plants is the instance of plants suppressed for Msh1 or derived from Msh1-suppressed plants. Other methods of inducing DNA methylation differences in plants can also produce epigenetically different plants.

As used herein, the term “progeny” refers to any one of a first, second, third, or subsequent generation obtained from a parent plant or two parent plants.

As used herein, the phrase “large scale” refers to one acre to several acres to several thousand, to tens of thousands or more acres of plants

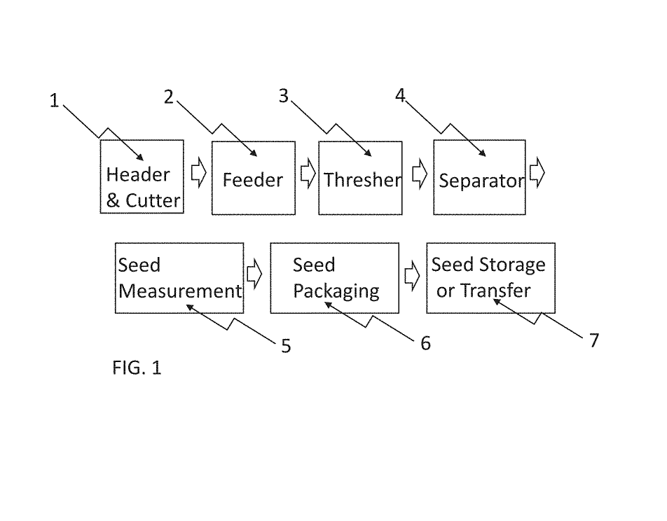

FIG. 1 indicates the order of the steps and units in the processing of the seeds in the single plant harvester. Plants enter the Head & Cutter unit 1 where the stem is cut and the plants are conveyed on the Feeder unit belt 2 into the Thresher unit 3. A Separator unit 4 separates the seeds from the unwanted non-seed plant materials. The seeds are sent to the Seed Measurement unit 5 and seeds from high yielding plants are sent to the Seed Packaging unit 6. Packaged seeds are sent to the Seed Storage or Transfer unit 7.

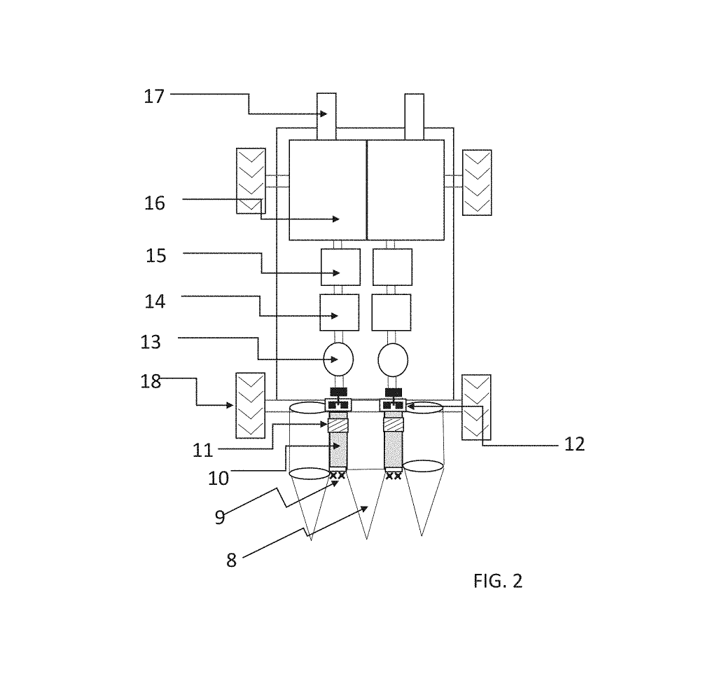

FIG. 2 more filly illustrates how these components are constructed on harvesters and each sectional unit is described below.

### Head & Cutter Unit

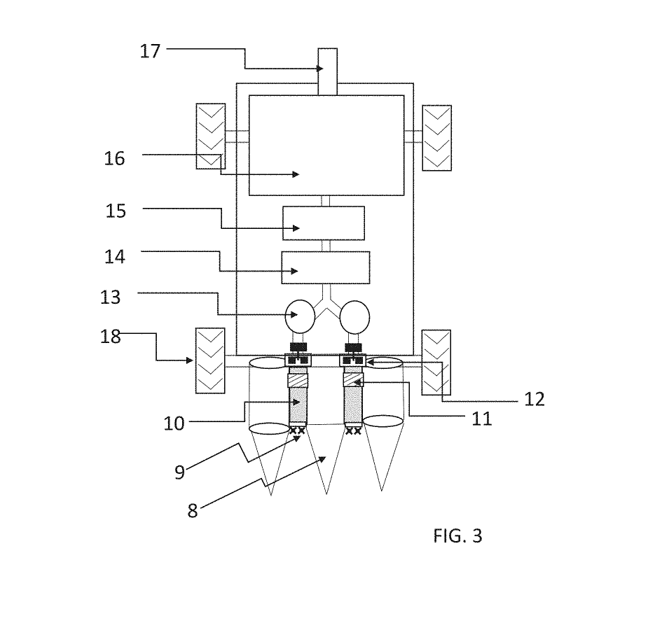

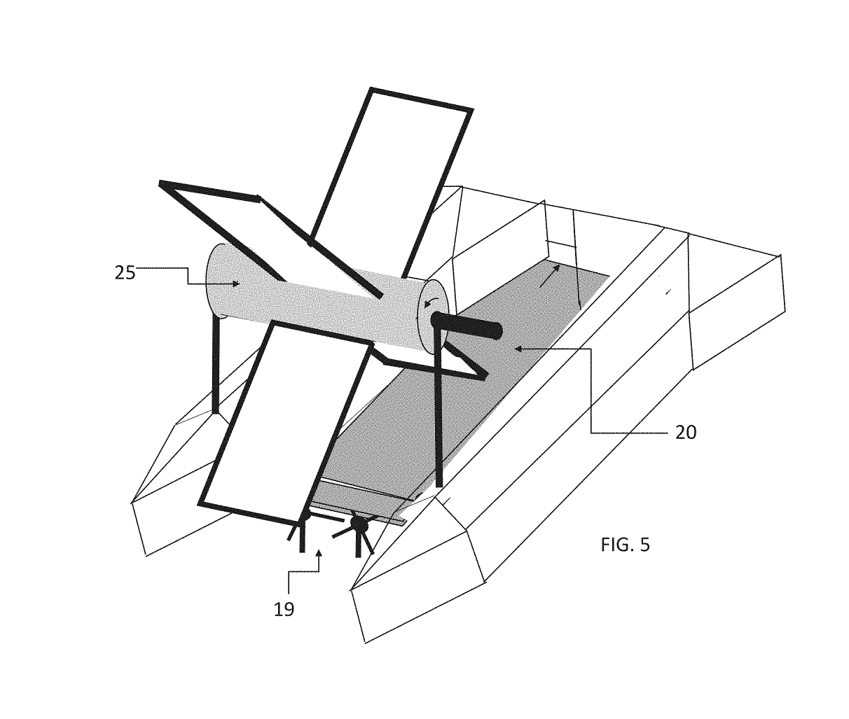

The Head unit's function is to guide an individual plant towards the stem Cutter 9. The Head 8 typically has flanking raised sides, often as a pointed cylinder or wedge, forming a V-shaped channel that moves the plant towards the cutters at the bottom of the V as the harvester moves forward (see also FIGS. 3, 6 and 7 of US Patent Application Publication No.: US2002/0043059 A1). The Cutter 9 cuts the plant stem several inches above the ground to minimize soil and rocks entering the harvester. A paddlewheel unit (not shown here but shown in FIG. 5) pushes the plants forward onto the feeder belt 10.

### Feeder Belt Conveyer and Feeder Drum

The cut plant is carried forward towards the feeder drum unit 11 by a feeder belt 10. The feeder drum serves to compress and break the plant parts into smaller units and moves them forward towards the thresher 12.

### Thresher Unit

The Thresher unit 12 can be a flexible beater type, a coated impeller, a transverse mounted thresher drum, or a parallel mounted thresher augur/drum combination of similar design to those in commercially available combines.

### Separator Unit

The Separator unit 13 consists of a cyclone separator as described (FIG. 3 of US Patent Application Publication No.: US 2002/0043059 A1) with an option variable air blower to help separate seeds from plant debris. Substitution of a computer-controlled electronically controlled exit valve allows the seeds to exit into a seed counter. Alternatively, a Separator unit 13 can consist of one or two separator plates with holes in the vibrating plates that allow individual seeds to fall below into a thresher collector tray while keeping the non-seed plant materials above the separator plates and pushed or blown out the back of the separator plates to exit from the harvester.

### Measurement Unit

The isolated seeds in the cyclone separator or thresher collector tray are transferred by air flow into the Measurement unit 14 which consists of commercially available seed counters and/or seed weighing machines or mass or volume measuring devices. Non-limiting embodiments of seed counters include: a Metrix Analytic Sorter made by Seedburo Equipment Company or a seed counter made by Seedburo.

Optionally a commercially available Near Infrared moisture measuring unit is integrated into the measuring step to provide a measure of seed moisture to allow for calculating the dry matter content of the seeds.

A gating valve at the exit of the Measurement unit 14 allows a decision to be made by a computer controller as to whether seeds are above the seed yield threshold and are to be sent to the Seed Packaging Unit 15 or to be considered from low yielding plants and sent to a bulk container for collection as commodity crop seeds or disposed of as field residue.

### Seed Packaging Unit

A set of seeds to be saved is sent from the Measurement Unit to the Seed Packaging Unit 15 by gravity or air flow. The Seed. Packaging Unit 15 uses a commercially available seed packaging machine, such as Almaco's single or dual automated seed packer or Elmor 800 packaging machine or ‘Old Mill Packeting Machine’ from International Marketing and Design Co. or the like, which places the seeds into an individual seed package, typically made of paper, plastic, or cloth or nylon or polyester mesh, and labels and seals the package. Alternatively a reel of nylon or polyester mesh of open seed bags can be used and each bag in the reel of bags sealed by a commercially available bag sealer once filled with seeds.

### Seed Storage or Transfer Unit

The individual packages or reels of seed packages are collected in the Seed Storage or Transfer unit for periodic collection on a reel when reels of seed bags are used, or loosely packed or stacked when seed packages are used. Alternatively, packaged seeds can be transferred to an adjacent storage/transport unit such as a truck or grain tank and transport to a storage site such as a seed storage facility. The Package or seed transfer unit 17 provides for transferring seed packages or reels of seeds packages to an external unit such as truck or grain truck unit.

FIG. 3 shows a single plant harvester similar to that shown in FIG. 2 except the harvester's two harvesting channels share the Seed Measurement 14, Seed Packaging 15, and Seed Storage or Transfer Units 16 and Package or seed transfer unit 17. The positions of the individual units in the processing chain can be varied to better fit the design of the engine platform and operator cab of the starting harvester framework while still accomplishing the purpose of harvesting and processing seeds from single plants. A high entry point into the Seed Storage or Transfer Unit is advantageous for filling this unit.

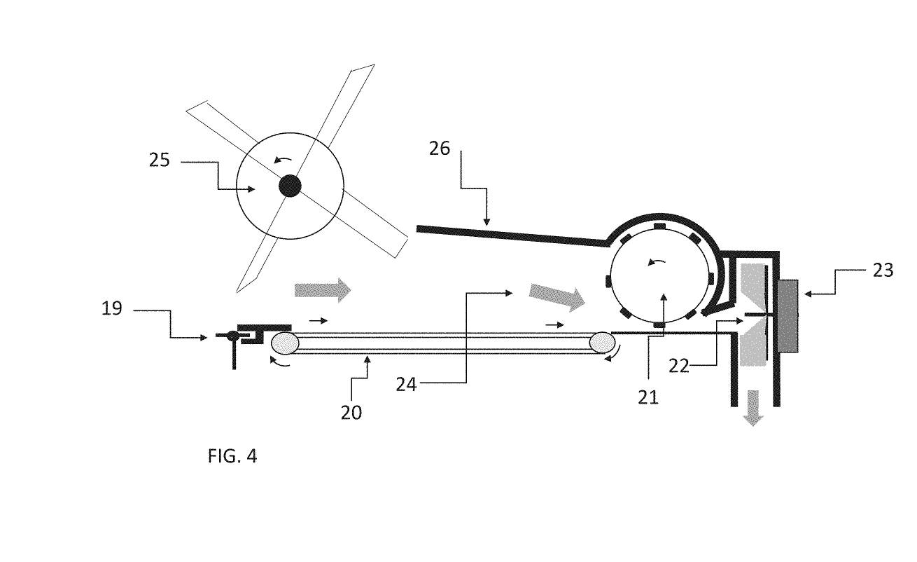

FIG. 4 provides a closer side view of the Head & Cutter, Feeder, and Thresher units. A paddlewheel 25 helps push the plants onto the feeder belt 20 after stem cutting by the cutters 19. The cutter blades cut the plant stems with the assistance of a cutter groove or plate 19 through which the cutter blade pass but the plant stem does not. The feeder drum 21 functions both as a thresher drum and a feeder into the second thresher unit, which is the impeller 22 in this embodiment. An impeller motor 23 drives the impeller blades. A plastic or metal enclosure 26 helps channel the plant materials into the feeder drum 21 and the thresher impeller 22. The air flow into the impeller chamber helps pull plant materials into the impeller chamber and the air flow out helps remove the threshed seeds and debris from the thresher chamber.

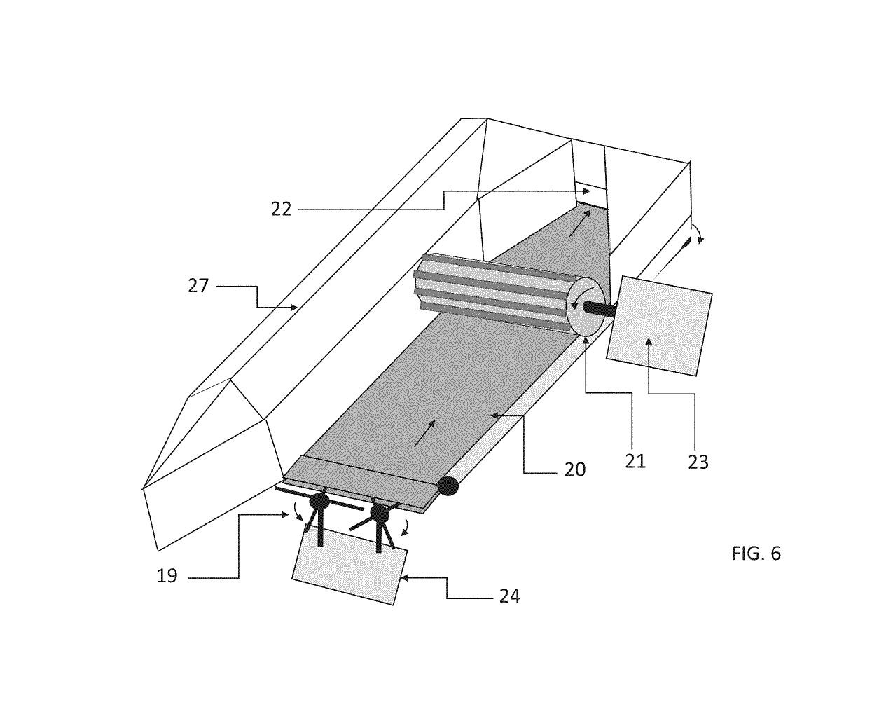

FIGS. 5 and 6 show an elevated perspective of the Head & Cutter and Feeder units. FIG. 5 displays a paddlewheel 25 that helps push the plants onto the feeder belt 20 after stem cutting by the cutters 19. FIG. 6: The cutter blades 19 powered by the cutter motor 24 cut the plant stems with the assistance of a cutter groove or plate 19 through which the cutter blade pass but the plant stem does not. The feeder drum 21 functions both as a thresher drum and a feeder into the thresher port 22. A thresher drum motor 23 drives the thresher drum.

### Crop Plants

A single plant harvester can be used for most seed crops. The methods described herein are most applicable to crops such as soybeans, wheat, cotton, rice, canola/rapeseed, barley, oats, rye, and sorghum.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

### An Impeller Thresher and Cyclone Separator Single Plant Harvester

A harvester machine partially based on the design of US Patent Application Publication No.: US 2002/0043059 A1, incorporated herein by reference in its entirety, is used to collect seeds from individual plants. In this design the separated seeds are located at the bottom of the cyclone separator above a valve controlling the exit of the seeds from the cyclone separator (FIG. 3 of US Patent Application Publication No.: US 2002/0043059 A1). Substitution of an electronically controlled exit valve allows the seeds to exit into a seed counter and either discarded to a bulk seed bin or be sent to the packaging unit for collection in the packaged seed bin provides for an automated individual plant seed harvester when placed on a motor pulled or driven rolling platform (as described in FIG. 8 of US Patent Application Publication No.: US2002/0043059 A1).

### Example 2

### An Augur/Impeller Thresher and Cyclone Separator Single Plant Harvester

A harvester machine based on the design of US Patent Application Publication No.: US2002/0043059 A1, incorporated herein by reference in its entirety, is used for to collect seeds from individual plants, wherein the ‘Third Embodiment Cutting Head’ is used (FIG. 7 of USPatent Application Publication No.: US 2002/0043059 A1). In this design the separated seeds are located at the bottom of the cyclone separator above a valve controlling the exit of the seeds from the cyclone separator (FIG. 3 of US Patent Application Publication No.: US 2002/0043059 A1). Substitution of an electronically controlled exit valve allows the seeds to exit into a seed counter and either discarded to a bulk seed bin or be sent to the packaging unit for collection in the packaged seed bin provides for an automated individual plant seed harvester when placed on a motor pulled or driven rolling platform (as described in 8 of US Patent Application Publication No.: US 2002/0043059 A1).

### Example 3

### An Engine Powered Single Plant Harvester

The design herein modifies the rolling platform of Example 1 or Example 2 to be that of an engine powered harvester of a standard 4-wheel design (such as Almaco's ‘Harvest Pro-HP5’) modified to harvest single plants. The engine powered harvester provides engine and electrical power such that the operator can ride on and steer the harvester to collect the seeds of individual plants sequentially along a row of individual plants separated by at least 6 inches, at least 12 inches, at least 18 inches, and preferably at least 24 inches. The operator advances the single plant harvester machine by the distance between the individual plants, preferably 24 inches, and stops the forward advance for sufficient time to process the individual plant seeds to be packaged before repeating this cycle in the next distance increment.

### Example 4

### An Engine Powered Multiple Independent Cchannel Ssingle Plant Harvester

The engine powered single plant harvester of Example 3 can contain two or more separate and independent harvesting streams as indicated in FIG. 2. That is, separate harvesting Head & Cutter units, Feeders, Threshers, Separators, Seed Measurement units, Seed Packaging units, and Seed Storage or Transfer units (See FIG. 1 for process flow). This allows harvesting of multiple single plants across multiple rows (harvesting a single plant from each row) at each forward incremental movement of the harvester. For example, a dual channel single plant harvester is shown in FIG. 2. Additional harvesting channels could be added to this design, preferably four to ten channels.

### Example 5

### An Engine Powered Multiple Channel Single Plant Harvester with Shared Measuring and Packaging Units

For single plant harvesters capable of separately harvesting two or more individual plants at the same time, sharing of some of the components of the harvesting units saves space and expense. For example, a single plant harvester with separate chains of Head & Cutter units, Feeders. Threshers, and Separators, but sharing a Seed Measurement unit, a Seed Packaging unit, and a Seed Storage or Transfer unit as displayed in FIG. 3. A computer controlled scheduling system determines when each lot of seeds from the individual Separators 13 is sent to the shared Seed Measurement unit 14, Seed Packaging unit 15, Seed Storage or Transfer unit 16 and Package or seed transfer unit 17. Air pressure to control air flow and seed flow through electronically-controlled gated valves and tubes moves the seeds from the individual Separators to the common Seed Measurement, Seed Packaging, and Seed Storage or Transfer units. Additional separate channels of Head & Cutter units, Feeders, Threshers, and Separators, but sharing a Seed Measurement unit, a Seed Packaging unit, and a Seed Storage or Transfer unit are envisioned capable of harvesting multiple separate individual plants at a single position along multiple rows of single plants. An exemplary but non-limiting number of multiple plants to be harvested are four to ten plants at a time. Many variations on the single plant harvester components are possible and available to those skilled in the art.

FIG. 4 shows a cross section of the Head & Cutter, Feeder, and Thresher units comprising an embodiment of a single plant harvester, but not showing the side Head guides on either side. Plants first encounter the paddle wheel 25 that push the plants down towards the feeder belt 20, onto which they fall when their stem is cut by the cutters 19. The plant is carried forward by the feeder belt 20 to the feeder/thresher drum 21, where the plants are broken into small pieces and seeds. The feeder belt then continues to carry plant parts and seeds to the thresher unit, in this case an impeller 22 that further separates the seeds from plant debris and also creates an air flow into and out of the impeller chamber. The paddle wheel, feeder/thresher drum, and impeller are all drive by electric or hydraulic motors. FIG. 5 shows an elevated view of the same Head & Cutter and Feeder units with the paddle wheel and side head guides more apparent. FIG. 6 shows an elevated view of the same Head & Cutter and Feeder units with the feeder drum/thresher more apparent.

### Example 6

### A System for Producing High Yielding Seeds from Epigenetically Enhanced Crop Varieties

In this example soybeans will be used but the system is applicable to most seeded crops. An epigenetically enhanced soybean variety is produced by suppression of Msh1 in soybean variety Thome as follows. A transgenic Thorne soybean plant is produced containing a transgene using the CaMV 355 promoter to express a RNAi hairpin construct targeted to the carboxyl terminal region of Msh1 to suppress Msh1 function and thereby produce useful epigenetic modifications as described in U.S. patent application Ser. No. 13/462,216, in U.S. Provisional 61/863,267, in U.S. Provisional 61/882,140, and in U.S. Provisional 61/901,349, each of which is incorporated herein by reference in their entirety.

Self pollination of a Thorne variety containing only one transgenic locus comprising a MShi RNAi silencing transgene produces progeny lacking the RNAi transgenic locus due to loss of the transgenic locus via chromosomal segregation in some of the progeny. This resulting ‘msh1-dr’ line contains no transgenes and has new epigenetic modifications, and is stable over multiple generations of self pollination, allowing for seed increases of this variety.

To initiate the production of higher yielding epigenetically enhanced soybeans (EpiLines), the Thorne msh1-dr line is crossed with a non-modified Thorne variety by emasculation of msh1-dr soybean flowers followed by pollination with Thorne pollen or the reciprocal cross direction. Either of these crosses produces F1 seeds with Thorne genetics and modified epigenetics. Plants from these EpiF1 Thorne seeds are allowed to self pollinate to produce EpiF2 seeds. EpiF2 soybean seeds are planted in rows (30″width) in a field with a 24 inch distance between the seeds along the row and the soybeans are grown under field growth conditions typical for growing soybeans. Optionally the seeds can be treated with commercial seed treatments comprising fungicides, and/or insecticides and/or Rhizobium inoculants according to the preference of the grower.

At maturity the EpiF2 plants are individually harvested with a single plant harvester. An initial calibration run of control Throne plants (no epigenetic modifications) and a number of EpiF2 plants, preferably at least 10 to 50 plants, establishes a range of individual plant yields. A yield threshold of seeds per plant (alternatively seed weight or mass or volume per plant can be used) is chosen such that 50% of the EpiF2 plants are above this threshold yield. This threshold value can be dynamically adjusted as larger numbers of EpiF2 plants are harvested during the post-calibration harvest process.

Plants are harvested with the single plant harvester, for example harvesters as described in one of the Examples 1 to 5, preferably Example 5, and EpiF3 seeds from EpiF2 plants with yields equal to or above the 50% yield threshold are retained in individual EpiF3 seed packages while seeds from the lower yielding plants are discarded into an adjacent grain truck for sale as regular commodity soybeans. Alternatively, seeds from all the plants can be packaged in labeled seed packages and the seed packages sorted post-harvest according to a user-defined threshold yield.

In a subsequent growing period to grow the EpiF3 seeds into EpiF3 plants, the individual EpiF3 seed packages are planted as ‘package to row or plot’ plantings such that one seed package is planted in one or more rows or plots associated with that package by GPS coordinates associated with the label on the seed package. Other row marking means such as planting stakes can be used to mark the rows or alternatively no markings are required as long as the plants in a row or plot are from a single EpiF3 seed package (from a single EpiF2 parent). Upon maturity the EpiF3 plants produce EpiF4 seeds which are harvested on a row or plot or multiple row or plot basis according to whether the ‘package to row or plot’ planting of a single seed package was in a single row or plot or multiple rows or plots. Alternatively, individual rows or plots representing a portion of a single seed package can be harvested.

Harvesting of the rows or plots can be accomplished with a conventional nursery plot combine capable of harvesting and weighing the yields of individual rows or plots (For example see ALMACO specialized combine SPC40). These row or plot yields can be used to decide whether a row or plot should be saved in bulk bins or packages or discarded (as bulk commodity soybeans). Higher yielding rows or plots can be saved to either sell as high yielding EpiF4 soybean seeds or to conduct another ‘package to row or plot’ seed production step to produce high yielding EpiF5 or later generations soybeans. Row or plot yields can be dynamically chosen by the operator, with saving the top 50% of the highest yielding rows or plots a useful guideline, although saving with a threshold value from a range of top 20% to 80% can also be used. Using a 50% yield threshold to determine which seed lots are to be saved, a 15% yield increase is obtained in yield trials in the next generation (EpiF4 seeds planted) relative to control non-epigenetically improved Thorne plants.

An important aspect of the present invention is the ability to grow and harvest single plants on a large scale of several acres to several thousand or more acres of plants. This large scale production and harvesting is necessary to be able to produce enough seeds for the next generation, which can be the final seed production step whose seeds are then sold to farmers. A critical feature of this production system is to be able to go from harvesting single plants on a large scale on the basis of their individual yields and use the seeds from these plants for the final seed production step or next to final seed production step if desired. The yields from this last step which is from rows or plots planted with seeds of individual plants can also be determined to decide whether to sell the seeds from each row or plot or to not sell those seeds. Optionally another production cycle could be used after this.

What is claimed is:

1. A large scale method of producing high yield potential EpiF3 seeds comprising:
a. harvesting EpiF3 seeds from individual EpiF2 plants with at least one single plant harvester that places said EpiF3 seeds into individual containers;
b. measuring the yields from individual EpiF2 plants before or after placing the EpiF3 seeds of step (a) into containers; and
c. saving high yield potential EpiF3 seeds harvested from individual EpiF2 plants with yields above a user set threshold.

2. The method of claim 1, wherein the individual EpiF2 plants are planted at least 0.3 ft, 0.6 ft, 1 ft, 1.5 ft, or 2 ft apart along the axis the single plant harvester travels along to harvest the plants.

3. The method of claim 1, wherein the seeds of at least 20%, 30%, 40%, or 50% of the individual plants are of step (c) are saved.

4. The method of claim 1, wherein high yielding EpiF4 seeds are produced from growing and harvesting high yield potential EpiF3 seeds produced by the method of claim 1.

5. The method of claim 1, wherein the individual EpiF2 plants of steps (a) and (b) are planted on an area of at least one acre.

6. A method of producing high yield potential seeds comprising:
a. planting at least one acre with high yield potential seeds in rows or plots;
b. harvesting and measuring yields of individual plants from at least one acre of plants grown from the seeds planted in step (a) with at least one single plant harvester; and
c. saving seeds of individual plants of step (b) with yields above a user set threshold yield.

7. The method of claim 6, wherein the seeds of at least 20%, 30%, 40%, or 50% of the individual plants are of step (c) are saved.

8. A single plant harvester comprising:
a. an engine powered platform; and
b. a single plant seed collection system comprising a head unit, feeder unit, thresher unit, separator unit, and a storage bin and/or an automated seed saving system comprising a seed packaging unit and a package storage bin or package transfer system.
